(19) United States
(12) Patent Application Publication
(10) Pub. No.: US 2018/0304572 A1
(43) Pub. Date: Oct. 25, 2018

(54) HOLLOW-STRUCTURE PLATE

(71) Applicant: UBE EXSYMO CO., LTD., Tokyo (JP)

(72) Inventor: Hideaki HOSHINO, Tokyo (JP)

(21) Appl. No.: 15/768,383

(22) PCT Filed: Dec. 19, 2016
(86) PCT No.: PCT/JP2016/087742

§ 371 Date: Apr. 13, 2018

(30) Foreign Application Priority Data
Dec. 25, 2015 (JP) 2015-253044

(51) Int. Cl. B31F 1/28; B32B 3/30; B32B 38/18; B32B 27/08

(52) U.S. Cl. CPC B31F 1/285; B32B 3/30; B32B 38/1866; B32B 2355/02; B32B 2274/00; B32B 2323/10; B32B 27/08

(57) ABSTRACT

A main object of the present technique is to provide a hollow-structure plate that is easy to process while retaining compressive strength. According to the present technique, there is provided a hollow-structure plate in which a surface material and/or a skin material are laminated to at least one surface of a hollow convex portion-formed sheet made from one or two thermoplastic resin sheets with a plurality of hollow convex portions on at least one surface, and at least part of a side wall of the convex portion has a bending radius R of 0.75 to 20 mm.

### TECHNICAL FIELD

The present invention relates to a hollow-structure plate, more specifically, to a hollow-structure plate that is easy to process while retaining compressive strength.

### BACKGROUND ART

A resin hollow-structure plate, which is light-weighted, excellent in chemical resistance, water resistance, heat insulation, sound insulation, and resilience, and is easy to handle, has found uses in a wide range of areas, such as box materials and packing materials in physical distribution, walls and ceiling panel materials in buildings, and also automobile materials. For example, Patent Literature 1 discloses a hollow-structure plate in which a corrugated synthetic resin member with corrugations repeatedly aligned at a predetermined pitch is sandwiched between two synthetic resin sheets arranged in parallel at a predetermined interval.

Patent Literature 2 discloses a TWINCONE (registered trademark) type of hollow-structure plate in which two thermoplastic resin sheets are thermally fused together with a plurality of protruding convex portions opposed to each other. The TWINCONE (registered trademark) type of hollow-structure plate is used in various technical fields as automobile interior materials, physical distribution materials, building materials, and others.

### CITATION LIST

### Patent Literatures

Patent Literature 1: JP-A No. 2003-170515
Patent Literature 2: JP-A No. 2007-83407

### SUMMARY OF THE INVENTION

### Technical Problem

The inventor of the subject application has earnestly studied structures of a hollow-structure plate focusing attention on the bending radius of at least part of the side wall of the convex portion, and has found that controlling the value of the bending radius within a predetermined range would make it possible to obtain a hollow-structure plate that is easy to process while retaining compressive strength, thereby completing the present invention.

### Solution to Problem

Accordingly, the present invention provides a hollow-structure plate in which a surface material and/or a skin material are laminated to at least one surface of a hollow convex portion-formed sheet made from one or two thermoplastic resin sheets with a plurality of hollow convex portions on at least one surface, and at least part of a side wall of the convex portion has a bending radius R of 0.75 to 20 mm.

### BRIEF DESCRIPTION OF DRAWINGS

FIG. 1 is a schematic perspective view of a structure of a hollow-structure plate 1 according to a first embodiment;

FIG. 2A is a schematic cross-sectional view of a cross-sectional structure of the hollow-structure plate 1 according to the first embodiment, and FIG. 2B is an enlarged view of an opening 212;

FIG. 3A is a schematic perspective view of a structure of a hollow-structure plate 1 according to a second embodiment, and FIG. 3B is a schematic view of FIG. 3A as seen from the direction of arrow;

FIG. 4 is a schematic perspective view of a structure of a hollow-structure plate 1 according to a third embodiment;

FIG. 5 is a schematic perspective view of a structure of a hollow-structure plate 1 according to a fourth embodiment;

FIG. 6 is a schematic perspective view of a structure of a hollow-structure plate 1 according to a fifth embodiment;

FIG. 7 is a schematic perspective view of a structure of a hollow-structure plate 1 according to a sixth embodiment;

FIG. 8 is a schematic perspective view of a structure of a hollow-structure plate 1 according to a seventh embodiment;

FIG. 9 is a schematic cross-sectional view of a cross-sectional structure of a hollow-structure plate 1 according to an eighth embodiment;

FIG. 10 is a conceptual diagram illustrating an example of a manufacturing method of the hollow-structure plate 1 according to the embodiment;

FIG. 11 is a conceptual diagram illustrating an example of a manufacturing method of the hollow-structure plate 1 different from that illustrated in FIG. 10 according to the embodiment;

FIG. 12 is a conceptual diagram illustrating an example of a manufacturing method of the hollow-structure plate 1 different from those illustrated in FIGS. 10 and 11 according to the embodiment;

FIGS. 13A to 13C are schematic diagrams illustrating the state of a crushing process; and

FIGS. 14A to 14C are diagrams illustrating schematically the state of a puncturing process.

### DESCRIPTION OF EMBODIMENTS

In the present invention, the ratio (a1/a2) between a long diameter length a1 and a short diameter length a2 of an opening of the convex portion can be set to 1.05≤a1/a2≤1.23.

In the present invention, the ratio (a1/a2) between the long diameter length a1 and the short diameter length a2 of the opening of the convex portion can also be set to 1.08≤a1/a2≤1.21.

In the present invention, the ratio (L/h) between total length L of a curve of the side wall of the convex portion with the bending radius R of 0.75 to 20 mm and height h of the convex portion can be set to 0.05≤L/h≤0.3.

In the present invention, the shortest distance between the openings of the convex portions can be set to 0.5 to 5 mm.

In the present invention, the shape of the convex portion can be a truncated cone, an elliptical frustum, or a truncated polygonal pyramid.

In the present invention, the shape of the opening of the convex portion can be an ellipse.

In the present invention, the hollow convex portion-formed sheet can be made from one thermoplastic resin sheet with the plurality of frustum-shaped convex portions on one surface and can be structured such that the surface material is laminated to the upper surfaces or openings, or both of the convex portions.

In the present invention, the hollow convex portion-formed sheet can be made from two thermoplastic resin sheets with the plurality of frustum-shaped convex portions on one each surface and can be structured such that the two thermoplastic resin sheets are fused together with the convex portions 21 opposed to each other.

Some of the conventional hollow-structure plates are known for high isotropy in physical properties. Such hollow-structure plates are excellent in compressive strength and are widely used as light-weight, high-stiffness plates. However, these hollow-structure plates may cause a problem due to high compressive strength that, when being processed by crushing or puncturing, some pressing marks are formed on the surface opposite to the processed surface, and therefore these plates are difficult to process.

In light of the foregoing circumstances, a main object of the present invention is to provide a hollow-structure plate that is easy to process while retaining compressive strength.

According to the present invention, it is possible to provide a hollow-structure plate that is easy to process while retaining compressive strength. The advantageous effect described herein is not a limited one but may be any of advantageous effects in the subject disclosure.

Preferred embodiments for carrying out the present invention will be described below in detail with reference to the drawings. The embodiments described below are examples of typical embodiments of the present invention, and the scope of the present invention should not be interpreted in a limited way due to the following embodiments.

### 1. Hollow-Structure Plate 1

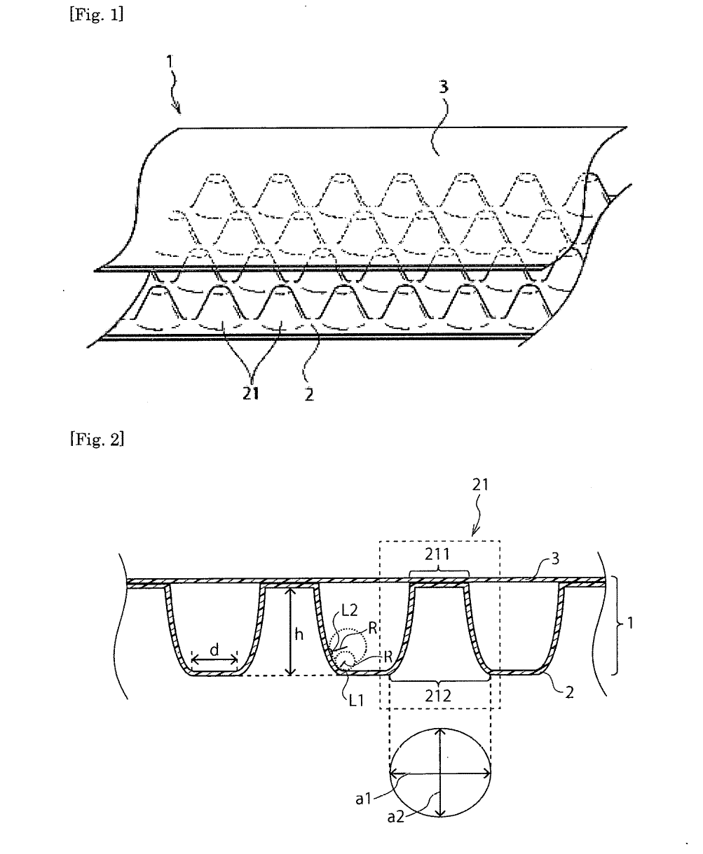

FIG. 1 is a schematic perspective view of a structure of a hollow-structure plate 1 according to a first embodiment. The hollow-structure plate 1 according to the embodiment is structured such that a surface material 3 and/or a skin material 4 is laminated to at least one surface of a hollow convex portion-formed sheet 2 made from one or two thermoplastic resin sheets with a plurality of hollow convex portions 21 on at least one surface.

Although there is no specific limitation, the basis weight of the hollow-structure plate 1 is preferably set to 300 to 6000 g/m², more preferably 400 to 4000 g/m². This enables weight reduction of the hollow-structure plate 1.

Although there is no specific limitation, the thickness of the hollow-structure plate 1 is preferably set to 1 to 55 mm. With a thickness of 1 mm or more, it is possible to achieve light weight of the hollow-structure plate 1 while preventing a too thin thickness. With a thickness of 55 mm or less, it is possible to control the height of the convex portions 21 on the hollow convex portion-formed sheet 2 and prevent the side walls of the convex portions 21 from being drafted and too thin. This makes it possible to produce the hollow-structure plate 1 that is unlikely to deform (buckle).

### <Hollow Convex Portion-Formed Sheet 2>

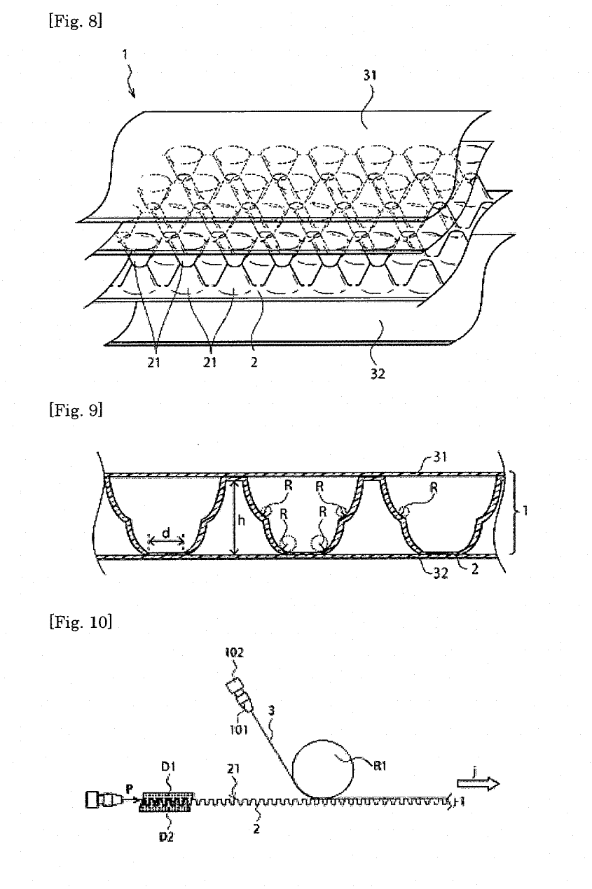

The hollow convex portion-formed sheet 2 is made from one or two thermoplastic resin sheets with the plurality of hollow convex portions 21 on at least one surface. That is, in the embodiment, the convex portions 21 may be formed only on one surface of the hollow convex portion-formed sheet 2 as illustrated in FIG. 1 and others, the convex portions 21 may be formed on the both surfaces of the hollow convex portion-formed sheet 2 as illustrated in FIG. 5, or the hollow convex portion-formed sheet 2 may be formed from two thermoplastic resin sheets as illustrated in FIG. 8.

FIG. 2A is a schematic cross-sectional view of a structure of the hollow-structure plate 1 according to the first embodiment. The embodiment is characterized in that the bending radius R of at least part of the side wall of the convex portion 21 is 0.75 to 20 mm.

As described above, some of the conventional hollow-structure plates are of high isotropy in physical properties, and such hollow-structure plates are difficult to process by crushing or puncturing due to high compressive strength.

Accordingly, the inventor of the subject application has earnestly studied structures of a hollow-structure plate and has found that setting the bending radius R to 0.75 to 20 mm would make it possible to obtain a hollow-structure plate that is easy to process while retaining compressive strength.

Specifically, setting the bending radius R to 0.75 mm or more makes it possible to prevent an inclination of the side walls of the convex portions 21 from becoming too large, and avoid deterioration in compressive strength caused by breakage of the side walls of the convex portions 21 under a load. In addition, setting the bending radius R to 20 mm or less makes it possible to prevent decrease in processability at the time of crushing and puncturing processes.

Controlling the bending radius R within the foregoing predetermined range makes it possible to prevent the occurrence of pressing marks or burrs on the surface of the plate opposite to the surface processed by crushing or puncturing, thereby also improving the designability of the processed hollow-structure plate 1.

In the embodiment, the bending radius R of at least part of the side walls of the convex portions 21 needs to fall within the foregoing range. That is, in the embodiment, when there is a plurality of bending radiuses R of the convex portions 21 as illustrated in FIGS. 2A and 9, at least one bending radius R needs to be 0.75 to 20 mm.

In the embodiment, however, it is more preferred that the bending radius R measured at the edge of the opening 212 of the convex portion 21 falls within the foregoing predetermined range as described later in relation to examples.

FIG. 2B is an enlarged view of the opening 212. In the embodiment, although there is no particular limitation, the ratio (a1/a2) between a long diameter length a1 and a short diameter length a2 of the opening 212 of the convex portion 21 is preferably set to 1.05≤a1/a2≤1.23.

Setting the ratio to a1/a2≥1.05 makes it possible to improve the convex portions 21 in the bending stiffness along the long diameter and avoid the bending of the convex portions 21 in a direction other than the given direction when the convex portions 21 are thermally bent in the short-diameter direction. Setting the ratio to a1/a2≤1.23 makes it possible to prevent the resin of the side walls of the convex portions 21 from being extended and too thin at the time of shaping and avoid deterioration in compressive strength.

In the embodiment, it is more preferred to set the ratio to 1.08≤a1/a2≤1.21. This makes it possible to provide a hollow-structure plate 1 that is improved in bending stiffness while retaining compressive strength.

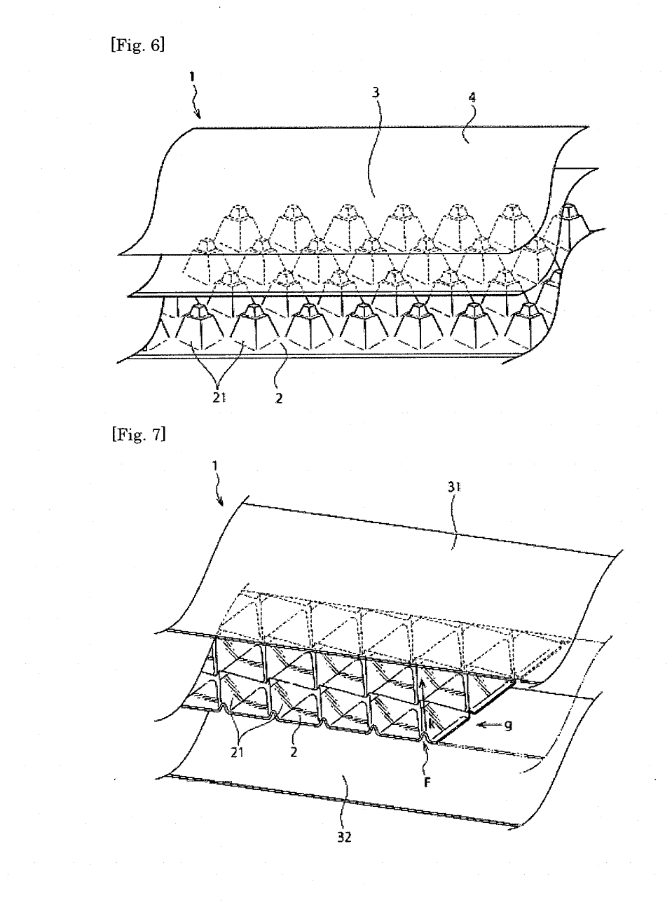

There is no particular limitation on the shape of the convex portions 21, and the convex portions 21 can be freely designed as far as they have at least an upper surface 211 and the opening 212 (see FIG. 2A). For example, the convex portions 21 can be designed in various shapes including an elliptical frustum as illustrated in FIG. 1 and others, truncated cone, truncated polygonal pyramid such as truncated triangular pyramid, truncated square pyramid, and truncated pentagonal pyramid, elliptic cylinder, cylinder, polygonal prism, polygonal star prism, and truncated polygonal star pyramid. In addition, the convex portions 21 may be designed in combination of these shapes as illustrated in FIG. 6.

In the embodiment, the convex portions 21 in the shape of a truncated polygonal pyramid or polygonal prism may have rounded corners, when the surface material 3 and the skin material 4 described later are laminated to the hollow convex portion-formed sheet 2, to improve the strength against separation from the surface material 3 and the skin material 4 by decreasing the starting points.

In the embodiment, among the foregoing shapes, the convex portions 21 are preferably designed in the shape of truncated cone, elliptical frustum, or truncated polygonal pyramid. Designing the convex portions 21 in the shape of truncated cone, elliptical frustum, or truncated polygonal pyramid makes it possible to facilitate the designing in the manufacturing process and reduce manufacturing costs for molding dies in the case of molding the convex portions 21 by molding dies.

In the embodiment, the convex portions 21 are more preferably designed in the shape of truncated cone or elliptical frustum, preferably in particular designed in the shape of elliptical frustum. This makes it possible to improve the hollow-structure plate 1 in bending stiffness while retaining compressive strength.

The plurality of convex portions 21 may be all identical in shape or may have a combination of freely selected two or more kinds of shapes. The convex portions 21 may have a step or a wave in the middle as illustrated in FIGS. 6 and 9.

In the embodiment, there is no particular limitation on the arrangement mode of the convex portions 21 but the convex portions 21 can be arranged in a grid pattern, a zigzag pattern, or an irregular pattern, for example. In the embodiment, among these patterns, the convex portions 21 are preferably arranged in a quadrangle grid pattern or a zigzag pattern, more preferably a zigzag pattern. This makes it possible to improve the hollow-structure plate 1 in bending stiffness while retaining compressive strength in a thickness direction.

Arranging the convex portions 21 in a zigzag pattern herein includes the mode in which the adjacent convex portions 21 are staggered as seen from a predetermined reference direction.

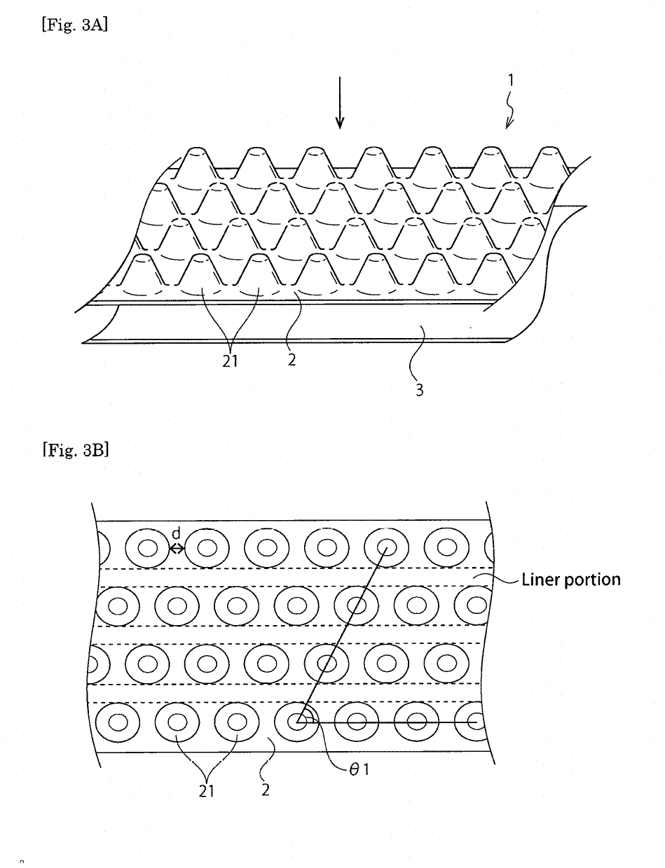

In the case of arranging the convex portions 21 in a zigzag pattern, although there is no particular limitation, an angle θ1 formed by the line connecting the centers of the convex portions 21 in the lateral direction and the line connecting the centers of the convex portions 21 in an oblique direction is preferably set to 60° in particular (see FIG. 3B). This makes it possible to improve the stiffness of the hollow-structure plate 1. The “quadrangle grid pattern” here means an arrangement at the angle θ1 of 90°.

Although there is no particular limitation on the shape of the openings 212, the openings 212 only need the long diameter and the short diameter in the case of 1.05≤a1/a2≤1.23, and the openings 212 are preferably elliptical in shape in particular. This makes it possible to improve the hollow-structure plate 1 in bending stiffness while retaining compressive strength.

There is no particular limitation on the upper surfaces 211 but the upper surfaces 211 can be formed in the shape of an ellipse, a true circle, or a polygon such as a triangle or a square.

Although there is no particular limitation, shortest distance d between the openings 212 in the convex portions 21 (see FIGS. 2A, 3B, and 9) is preferably set to 0.5 to 5 mm. Setting the shortest distance d to 0.5 mm or more makes it possible to prevent liner portions (portions without the convex portions 21 as seen from a specific direction, see FIG. 3B) from being too thin, thereby avoiding deterioration in compressive strength. Setting the shortest distance d to 5 mm or less makes it possible to avoid excessive decrease in the number of convex portions 21 per unit plane resulting from the too long distance between the convex portions 21, thereby retaining the bending stiffness of the hollow-structure plate 1 at a specific level or higher. In the embodiment, the shortest distance d may not be uniform constantly.

In the embodiment, although there is no particular limitation, the ratio (L/h) between total length L of a curve of the side wall of the convex portion 21 with the bending radius R of 0.75 to 20 mm and height h of the convex portion 21 is preferably set to 0.05≤L/h≤0.3.

Setting the ratio to L/h≥0.05 makes it possible to prevent reduction in the effect of crushing and puncturing processes. Setting the ratio to L/h≤0.3 makes it possible to prevent an inclination of the side walls of the convex portions 21 from being too large and avoid deterioration in compressive strength caused by breakage of the side walls of the convex portions 21 under a load.

When there is a plurality of bending radiuses R of the convex portion 21 as illustrated in FIG. 2A, in the embodiment, the total length (L1+L2) of the curves with the bending radiuses R within a range of 0.75 to 20 mm (all the bending radiuses R fall within this range in FIG. 2A) is designated as total length L. That is, in the embodiment, the length of the curve with the bending radius R outside this range is not used in the calculation of the total length L.

Although there is no particular limitation, the height h of the convex portions 21 (see FIG. 2A) is preferably set to 1.5 mm or more. Setting the height h to 1.5 mm or more makes it possible to obtain the hollow-structure plate 1 with high stiffness. In addition, the height h is preferably set to 50 mm or less. Setting the height h to 50 mm or less makes it possible to prevent the side walls of the convex portions 21 from being too thin and save the deformation of the hollow convex portion-formed sheet 2.

In the embodiment, the hollow convex portion-formed sheet 2 may be structured such that a flow path F is provided in part of the sheet as illustrated in FIG. 7. In the embodiment, there are no particular limitations on the shape and structure of the cross section of the flow path F. Arrow k in FIG. 7 represents the formation direction of the flow path F. There is no particular limitation on the formation direction of the flow path F but the flow path F may be formed obliquely as seen from the direction of arrow g as illustrated in FIG. 7, for example.

There is no particular limitation on the component for the hollow convex portion-formed sheet 2 as far as it is a thermoplastic resin. In general, one or two or more kinds of thermoplastic resins usable for a hollow-structure plate can be used alone or in arbitrary combination.

The foregoing thermoplastic resins may include, for example, polyethylene (PE), polypropylene (PP), polystyrene (PS), polyurethane, polycarbonate (PC), polymethyl methacrylate (PMMA), and others.

Among the foregoing substances, the component for the hollow convex portion-formed sheet 2 is preferably an olefin resin such as low-density polyethylene, high-density polyethylene (HDPE), linear low-density polyethylene, ultralow-density polyethylene, polypropylene homopolymer, polypropylene random copolymer, or polypropylene block copolymer, from the viewpoints of processability, cost, weight, and physical properties. In addition, in the embodiment, the component for the hollow convex portion-formed sheet 2 may be an engineering plastic such as an ABS resin or a polycarbonate for further high stiffness.

In the embodiment, the thermoplastic resins for forming the hollow convex portion-formed sheet 2, the surface material 3 and the skin material 4 described later may be blended with fillers such as talc, mica, and calcium carbonate, and chopped strands such as glass fiber, aramid fiber, and carbon fiber.

In addition, the thermoplastic resins for forming the hollow convex portion-formed sheet 2, and the surface material 3 and the skin material 4 described later may be blended with modifiers for improving flame resistance, conductivity, wettability, slidability, and weatherability, and coloring agents such as pigments.

The hollow convex portion-formed sheet 2, and the surface material 3 and the skin material 4 described later may be formed from the same component or different components within a range capable of thermal fusing.

### <Surface Material 3 (31 and 32)>

In the embodiment, the surface material 3 and/or the skin material 4 described later are laminated to at least one surface of the hollow convex portion-formed sheet 2. That is, in the embodiment, the hollow-structure plate 1 may have only the surface material 3 (31 and 32) or the skin material 4 (41 and 42) laminated to the hollow convex portion-formed sheet 2 as illustrated in FIGS. 1 to 4 and 7 to 9, or both the surface material 3 and the skin material 4 may be laminated to the hollow convex portion-formed sheet 2 as illustrated in FIG. 6, or the surface material 3 and the skin material 4 may be laminated to one each surface of the hollow convex portion-formed sheet 2 as illustrated in FIG. 5.

The two surface materials laminated to the hollow convex portion-formed sheet 2 may also be called a first surface material 31 and a second surface material 32 herein and in the drawings, but these designations are only for the sake of convenience. Therefore, the first surface material 31 and the second surface material 32 are not distinguished in the hollow-structure plate 1 as an actual product. In the following description of examples, in particular, the surface material 3 laminated to the upper surfaces 211 side of the convex portions 21 will be called “first surface material 31” and the surface material 3 laminated to the openings 212 side of the convex portions 21 will be called “second surface material 32”, for the sake of convenience.

There is no particular limitation on the component for the surface material 3, but in general, one or two or more kinds of components usable for a hollow-structure plate can be used alone or in arbitrary combination. Specifically, the component for the surface material 3 may be a thermoplastic resin, a thin metal sheet, or the like, for example. Specific examples of the thermoplastic resin are the same as listed above, and thus descriptions thereof are omitted here.

Among the foregoing ones, the component for the surface material 3 is preferably a thermoplastic resin, more preferably an olefin resin such as low-density polyethylene, high-density polyethylene (HDPE), linear low-density polyethylene, ultralow-density polyethylene, polypropylene homopolymer, polypropylene random copolymer, or polypropylene block copolymer, from the viewpoints of processability, cost, weight, and physical properties. In addition, in the embodiment, the component for the surface material 3 may be an engineering plastic such as an ABS resin or a polycarbonate for further high stiffness.

In the embodiment, the basis weight and thickness of the surface material 3 are not particularly limited but can be set to arbitrary basis weight and thickness.

In the embodiment, when the hollow-structure plate 1 has a plurality of surface materials 3, the plurality of surface materials 3 may be identical or different in thickness. The surface materials may be formed from the same component or different components.

As described above, although there is no particular limitation on the structure of the hollow-structure plate 1 according to the embodiment, the hollow-structure plate 1 can be structured such that the hollow convex portion-formed sheet 2 is made from one thermoplastic resin sheet with the plurality of frustum-shaped convex portions 21 on one surface, and the surface material 3 (31 and 32) is laminated to the upper surfaces 211 or the openings 212, or both of the convex portions 21 as illustrated in FIGS. 1 to 4. According to this structure, it is possible to provide the hollow-structure plate 1 that is easy to process while retaining plane compressive strength. The thus structured hollow-structure plate can be manufactured by manufacturing methods illustrated in FIGS. 10 and 11 described later, for example.

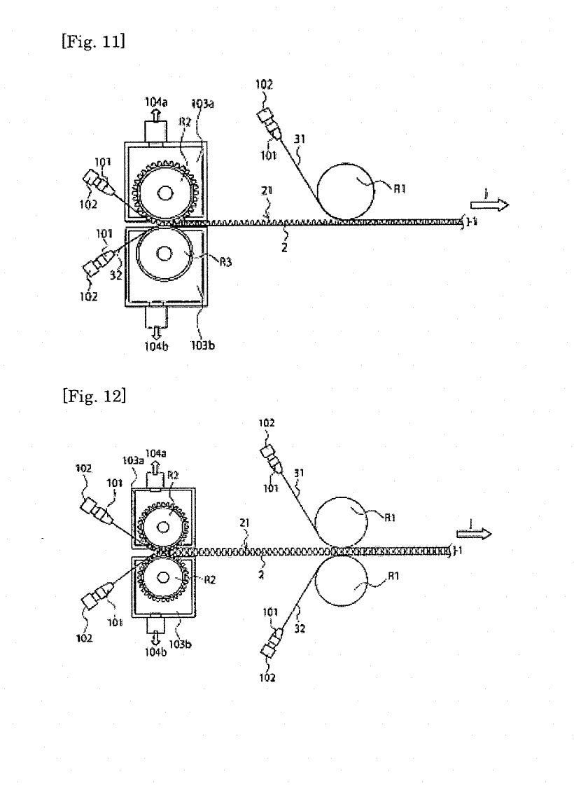

In addition, the hollow-structure plate 1 according to the embodiment can be structured such that the hollow convex portion-formed sheet 2 is made from two thermoplastic resin sheets with the plurality of frustum-shaped convex portions 21 on one surface, and the two thermoplastic resin sheets are fused together with the convex portions 21 opposed to each other as illustrated in FIG. 8. According to this structure, it is possible to provide the hollow-structure plate 1 that is unlikely to warp and excellent in bending stiffness. The thus structured hollow-structure plate can be manufactured by a manufacturing method illustrated in FIG. 12 described later, for example.

### <Skin Material 4 (41 and 42)>

In the embodiment, the surface material 3 and/or the skin material 4 are laminated to at least one surface of the hollow convex portion-formed sheet 2. Including the skin material 4 in the hollow-structure plate 1 according to the embodiment makes it possible to impart such properties as designability, sound absorption, and heat insulation to the hollow-structure plate 1 depending on the intended use.

The two skin materials laminated to the hollow convex portion-formed sheet 2 may also be called a first skin material 41 and a second skin material 42 herein and in the drawings, but these designations are only for the sake of convenience. Therefore, the first skin material 41 and the second skin material 42 are not distinguished in the hollow-structure plate 1 as an actual product. In addition, in the following description of examples, the skin material 4 laminated to the upper surfaces 211 side of the convex portions 21 will be called “first skin material 41” and the skin material 4 laminated to the openings 212 side of the convex portions 21 will be called “second skin material 42”, for the sake of convenience.

There is no particular limitation on the component for the skin material 4, but in general, a component usable for a skin material of a hollow-structure plate can be freely selected depending on the intended use. For example, the component for the skin material 4 may be a thermoplastic resin sheet, resin woven fabric, non-woven fabric, braid fabric, knitted fabric, metal sheet made of stainless steel, aluminum, or copper, organic or inorganic porous sheet. In addition, the skin material may be formed from a laminated sheet in which a plurality of sheets of the same or different kinds is laminated.

In the embodiment, when the hollow-structure plate 1 has a plurality of skin materials 4, the plurality of skin materials 4 may be identical or different in thickness. The skin materials may be formed from the same component or different components.

### 2. Manufacturing Method of the Hollow-Structure Plate 1

The hollow-structure plate 1 according to the embodiment is characterized by its structure and thus there is no particular limitation on the manufacturing method. That is, the hollow-structure plate 1 according to the embodiment can be manufactured by one or two or more freely selected kinds of manufacturing methods for a hollow-structure plate. FIGS. 10 to 12 indicate the flow direction of the hollow-structure plate 1 by arrow j.

FIG. 10 is a conceptual diagram illustrating an example of a manufacturing method of the hollow-structure plate 1 according to the embodiment. According to the manufacturing method illustrated in FIG. 10, first, a molten thermoplastic resin P is pressed by molding dies D1 and D2 from the both sides to produce a hollow convex portion-formed sheet 2 structured as illustrated in FIG. 1. Next, a thermoplastic resin is extruded from an extruder 102 with a T die 101 at the leading end to produce the surface material 3 in a sheet form, and the surface material 3 is laminated to the hollow convex portion-formed sheet 2 by thermal fusing using a roller R1 with a heating unit, thereby manufacturing the hollow-structure plate 1 according to the embodiment.

FIG. 11 is a conceptual diagram illustrating an example of a manufacturing method of the hollow-structure plate 1 different from that illustrated in FIG. 10 according to the embodiment. According to the manufacturing method illustrated in FIG. 11, first, a molten thermoplastic resin sheet is injected into grooves in a shaping roller R2 with a plurality of convex pins protruding from the surface to produce the hollow convex portion-formed sheet 2. Next, the second surface material 32 is laminated to one surface of the hollow convex portion-formed sheet 2 by thermal fusing using a flat roller R3 with a flat surface, and then the first surface material 31 is laminated to the other surface of the hollow convex portion-formed sheet 2 by thermal fusing using the roller R1 with the heating unit, thereby manufacturing the hollow-structure plate 1 according to the embodiment.

According to the manufacturing method illustrated in FIG. 11, the hollow convex portion-formed sheet 2 is manufactured by a vacuum shaping apparatus in which the shaping roller R2 with the plurality of convex pins protruding from the surface and the flat roller R3 with the flat surface are arranged with rotation axes parallel to each other. The shaping roller R2 and the flat roller R3 are installed in decompression chambers 103a and 103b, respectively. The decompression chambers 103a and 103b may be provided with suction holes 104a and 104b to suck and hold the hollow convex portion-formed sheet 2 and the surface materials 31 and 32 as illustrated in FIG. 11.

FIG. 12 is a conceptual diagram illustrating an example of a manufacturing method of the hollow-structure plate 1 different from those illustrated in FIGS. 10 and 11 according to the embodiment. According to the manufacturing method illustrated in FIG. 12, first, a molten thermoplastic resin sheet is injected into grooves in two shaping rollers R2 to produce the hollow convex portion-formed sheet 2 structured as illustrated in FIG. 8. Next, the first surface material 31 and the second surface material 32 are laminated to the both surfaces of the hollow convex portion-formed sheet 2 by the roller R1 with the heating unit, thereby manufacturing the hollow-structure plate 1 according to the embodiment. According to the manufacturing method illustrated in FIG. 12, the hollow convex portion-formed sheet 2 is produced by a vacuum shaping apparatus. The vacuum shaping apparatus is the same as that used in the manufacturing method illustrated in FIG. 11, and thus descriptions thereof will be omitted here.

Although not illustrated, in the case of laminating the skin material 4 to the hollow-structure plate 1, in the manufacturing methods described above with reference to FIGS. 10 to 12, the skin surface 4 (41 and 42) may be laminated to the hollow convex portion-formed sheet 2 instead of the surface material 3 (31 and 32), or the skin material 4 may be laminated to the surface material 3 by the roller R1 with the heating unit or the flat roller R3 with the flat surface.

### EXAMPLES

The embodiment will be described below in more detail based on examples. The examples described below are typical examples of the embodiment, and the scope of the present invention should not be interpreted in a limited way due to these examples.

### 1. Test Method and Test Results

First, hollow-structure plates as examples 1 to 19 and comparative examples 1 to 6 described in Tables 1 and 2 shown below were produced.

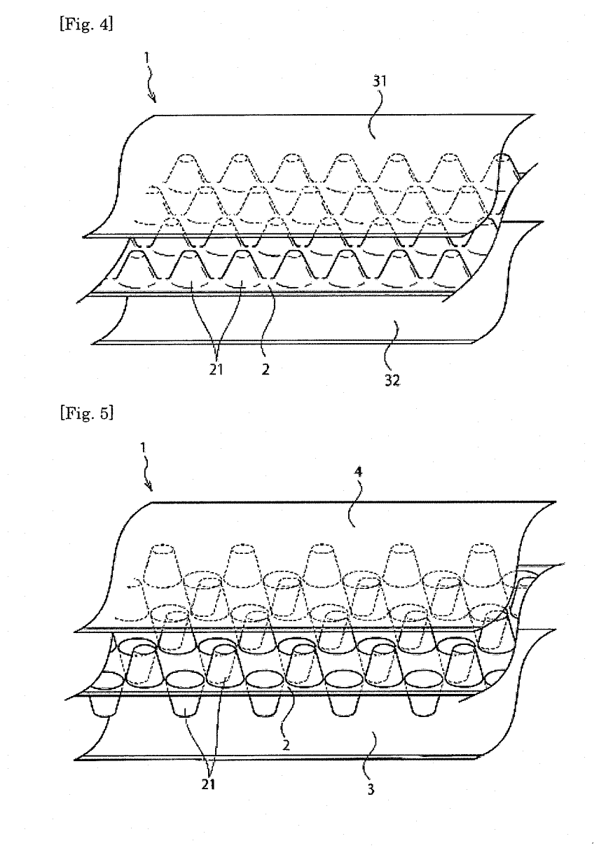

For the hollow-structure plates of examples 1 to 15 and comparative examples 1 to 6, the structure illustrated in FIG. 1 was produced by the manufacturing method illustrated in FIG. 10. For the hollow-structure plate of example 16, the structure illustrated in FIG. 3 was produced by the manufacturing method illustrated in FIG. 10. For the hollow-structure plate of example 17, the structure illustrated in FIG. 8 was produced by the manufacturing method illustrated in FIG. 10. For the hollow-structure plate of example 18, the structure illustrated in FIG. 7 was produced by the manufacturing method illustrated in FIG. 10. For the hollow-structure plate of example 19, the structure illustrated in FIG. 4 was produced by the manufacturing method illustrated in FIG. 10.

TABLE 1

| | | | Example | Example | Example | Example | Example | Example | Example |
|---|---|---|---|---|---|---|---|---|---|
| | Item | Unit | 1 | 2 | 3 | 4 | 5 | 6 | 7 |
| Hollow- | Basis weight | g/m² | 600 | 600 | 600 | 600 | 600 | 600 | 600 |
| structure plate | Thickness | mm | 5.3 | 5.3 | 5.3 | 5.3 | 5.3 | 5.3 | 5.3 |
| Hollow convex | Resin type | — | PP | PP | PP | PP | PP | PP | PP |
| portion-formed | Hollow convex | mm | 5 | 5 | 5 | 5 | 5 | 5 | 5 |
| sheet | portion height h | | | | | | | | |
| | Bending radius R | mm | 3 | 3 | 3 | 0.75 | 20 | 3 | 3 |
| | Curve length L | mm | 0.5 | 0.5 | 0.5 | 0.5 | 0.5 | 0.25 | 1.5 |
| | L/h | — | 0.1 | 0.1 | 0.1 | 0.1 | 0.1 | 0.05 | 0.3 |
| | Shortest distance d | mm | 1 | 1 | 1 | 1 | 1 | 1 | 1 |
| | between openings | | | | | | | | |
| | Long-diameter | mm | 6 | 6 | 6 | 6 | 6 | 6 | 6 |
| | length a1 of opening | | | | | | | | |
| | Short-diameter | mm | 6 | 4.5 | 5.5 | 5.5 | 5.5 | 5.5 | 5.5 |
| | length a2 of opening | | | | | | | | |
| | a1/a2 | — | 1.0 | 1.33 | 1.09 | 1.09 | 1.09 | 1.09 | 1.09 |
| First surface | Resin type | — | PP | PP | PP | PP | PP | PP | PP |
| material | Basis weight | g/m² | 250 | 250 | 250 | 250 | 250 | 250 | 250 |
| | Thickness | mm | 0.3 | 0.3 | 0.3 | 0.3 | 0.3 | 0.3 | 0.3 |
| Second surface | Resin type | — | N/A | N/A | N/A | N/A | N/A | N/A | N/A |
| material | Basis weight | g/m² | N/A | N/A | N/A | N/A | N/A | N/A | N/A |
| | Thickness | mm | N/A | N/A | N/A | N/A | N/A | N/A | N/A |
| Evaluation | Compressive | Mpa | 1.25 | 0.80 | 1.05 | 0.90 | 1.20 | 1.20 | 0.95 |
| | strength | | | | | | | | |
| | Crushing | — | ◯ | ◯ | ◯ | ◯ | ◯ | ◯ | ◯ |
| | processability | | | | | | | | |
| | Puncturing | — | ◯ | ◯ | ◯ | ◯ | ◯ | ◯ | ◯ |
| | processability | | | | | | | | |
| | Occurrence rate of | % | 15 | 15 | 5 | 5 | 10 | 10 | 5 |
| | breakage and burrs | | | | | | | | |
| | Occurrence of | — | ◯ | ◯ | ⊚ | ⊚ | ⊚ | ⊚ | ⊚ |
| | breakage and burrs | | | | | | | | |

| | | | Example | Example | Example | Example | Example | Example |
|---|---|---|---|---|---|---|---|---|
| | Item | Unit | 8 | 9 | 10 | 11 | 12 | 13 |
| Hollow- | Basis weight | g/m² | 600 | 600 | 600 | 600 | 600 | 450 |
| structure plate | Thickness | mm | 5.3 | 5.3 | 5.3 | 5.3 | 5.3 | 1.8 |
| Hollow convex | Resin type | — | PP | PP | PP | PP | PP | PP |
| portion-formed | Hollow convex | mm | 5 | 5 | 5 | 5 | 5 | 1.5 |
| sheet | portion height h | | | | | | | |
| | Bending radius R | mm | 3 | 3 | 3 | 3 | 3 | 3 |
| | Curve length L | mm | 0.5 | 0.5 | 0.5 | 0.5 | 0.5 | 0.15 |
| | L/h | — | 0.1 | 0.1 | 0.1 | 0.1 | 0.1 | 0.1 |
| | Shortest distance d | mm | 0.5 | 5 | 1 | 1 | 1 | 1 |
| | between openings | | | | | | | |
| | Long-diameter | mm | 6 | 6 | 7 | 6 | 6 | 6 |
| | length a1 of opening | | | | | | | |
| | Short-diameter | mm | 5.5 | 5.5 | 5.7 | 5.7 | 5.5 | 5.5 |
| | length a2 of opening | | | | | | | |
| | a1/a2 | — | 1.09 | 1.09 | 1.23 | 1.05 | 1.09 | 1.09 |
| First surface | Resin type | — | PP | PP | PP | PP | PP | PP |
| material | Basis weight | g/m² | 250 | 250 | 250 | 250 | 250 | 100 |
| | Thickness | mm | 0.3 | 0.3 | 0.3 | 0.3 | 0.3 | 0.3 |
| Second surface | Resin type | — | N/A | N/A | N/A | N/A | N/A | N/A |
| material | Basis weight | g/m² | N/A | N/A | N/A | N/A | N/A | N/A |
| | Thickness | mm | N/A | N/A | N/A | N/A | N/A | N/A |
| Evaluation | Compressive | Mpa | 1.15 | 0.85 | 0.90 | 1.15 | 1.00 | 1.15 |
| | strength | | | | | | | |
| | Crushing | — | ◯ | ◯ | ◯ | ◯ | ◯ | ◯ |
| | processability | | | | | | | |
| | Puncturing | — | ◯ | ◯ | ◯ | ◯ | ◯ | ◯ |
| | processability | | | | | | | |
| | Occurrence rate of | % | 10 | 5 | 5 | 10 | 5 | 15 |
| | breakage and burrs | | | | | | | |
| | Occurrence of | — | ⊚ | ⊚ | ⊚ | ⊚ | ⊚ | ◯ |
| | breakage and burrs | | | | | | | |

TABLE 2

| | | | Example | Example | Example | Example | Example | Example | Comparative |
|---|---|---|---|---|---|---|---|---|---|
| | Item | Unit | 14 | 15 | 16 | 17 | 18 | 19 | example 1 |
| Hollow- | Basis weight | g/m² | 2350 | 600 | 600 | 1100 | 1100 | 1000 | 600 |
| structure plate | Thickness | mm | 50.3 | 5.3 | 5.3 | 10.4 | 10.4 | 5.7 | 5.3 |
| Hollow convex | Resin type | — | PP | ABS | PP | PP | PP | PP | PP |
| portion-formed | Hollow convex | mm | 50 | 5 | 5 | 10(5 × 2) | 10(5 × 2) | 5 | 5 |
| sheet | portion height h | | | | | | | | |
| | Bending radius R | mm | 3 | 3 | 3 | 3 | 3 | 3 | 0.6 |
| | Curve length L | mm | 5 | 0.5 | 0.5 | 0.5 | 0.5 | 0.5 | 0.5 |
| | L/h | — | 0.1 | 0.1 | 0.1 | 0.1 | 0.1 | 0.1 | 0.1 |
| | Shortest distance d | mm | 1 | 1 | 1 | 1 | 1 | 1 | 1 |
| | between openings | | | | | | | | |
| | Long-diameter | mm | 6 | 6 | 6 | 6 | 6 | 6 | 6 |
| | length a1 of opening | | | | | | | | |
| | Short-diameter | mm | 5.5 | 5.5 | 5.5 | 5.5 | 5.5 | 5.5 | 5.5 |
| | length a2 of opening | | | | | | | | |
| | a1/a2 | — | 1.09 | 1.09 | 1.09 | 1.09 | 1.09 | 1.09 | 1.09 |
| First surface | Resin type | — | PP | ABS | N/A | PP | PP | PP | PP |
| material | Basis weight | g/m² | 2000 | 250 | N/A | 200 | 200 | 400 | 250 |
| | Thickness | mm | 0.3 | 0.3 | N/A | 0.2 | 0.2 | 0.4 | 0.3 |
| Second surface | Resin type | — | N/A | N/A | PP | PP | PP | PP | N/A |
| material | Basis weight | g/m² | N/A | N/A | 250 | 200 | 200 | 250 | N/A |
| | Thickness | mm | N/A | N/A | 0.3 | 0.2 | 0.2 | 0.3 | N/A |
| Evaluation | Compressive | Mpa | 1.15 | 1.25 | 0.95 | 1.05 | 1.05 | 1.00 | 0.50 |
| | strength | | | | | | | | |
| | Crushing | — | ◯ | ◯ | ◯ | ◯ | ◯ | ◯ | X |
| | processability | | | | | | | | |
| | Puncturing | — | ◯ | ◯ | ◯ | ◯ | ◯ | ◯ | X |
| | processability | | | | | | | | |
| | Occurrence rate of | % | 15 | 15 | 5 | 5 | 5 | 5 | 25 |
| | breakage and burrs | | | | | | | | |
| | Occurrence of | — | ◯ | ◯ | ⊚ | ⊚ | ⊚ | ⊚ | X |
| | breakage and burrs | | | | | | | | |

| | | | Comparative | Comparative | Comparative | Comparative | Comparative |
|---|---|---|---|---|---|---|---|
| | Item | Unit | example 2 | example 3 | example 4 | example 5 | example 6 |
| Hollow- | Basis weight | g/m² | 600 | 600 | 600 | 600 | 600 |
| structure plate | Thickness | mm | 5.3 | 5.3 | 5.3 | 5.3 | 5.3 |
| Hollow convex | Resin type | — | PP | PP | PP | PP | PP |
| portion-formed | Hollow convex | mm | 5 | 5 | 5 | 5 | 5 |
| sheet | portion height h | | | | | | |
| | Bending radius R | mm | 25 | 3 | 3 | 3 | 3 |
| | Curve length L | mm | 0.5 | 0.1 | 2.5 | 0.5 | 0.5 |
| | L/h | — | 0.1 | 0.02 | 0.5 | 0.1 | 0.1 |
| | Shortest distance d | mm | 1 | 1 | 1 | 0.4 | 6 |
| | between openings | | | | | | |
| | Long-diameter | mm | 6 | 6 | 6 | 6 | 6 |
| | length a1 of opening | | | | | | |
| | Short-diameter | mm | 5.5 | 5.5 | 5.5 | 5.5 | 5.5 |
| | length a2 of opening | | | | | | |
| | a1/a2 | — | 1.09 | 1.09 | 1.09 | 1.09 | 1.09 |
| First surface | Resin type | — | PP | PP | PP | PP | PP |
| material | Basis weight | g/m² | 250 | 250 | 250 | 250 | 250 |
| | Thickness | mm | 0.3 | 0.3 | 0.3 | 0.3 | 0.3 |
| Second surface | Resin type | — | N/A | N/A | N/A | N/A | N/A |
| material | Basis weight | g/m² | N/A | N/A | N/A | N/A | N/A |
| | Thickness | mm | N/A | N/A | N/A | N/A | N/A |
| Evaluation | Compressive | Mpa | 1.60 | 1.65 | 0.35 | Shaping | 0.35 |
| | strength | | | | | disabled | |
| | Crushing | — | X | X | X | — | X |
| | processability | | | | | | |
| | Puncturing | — | X | X | X | — | X |
| | processability | | | | | | |
| | Occurrence rate of | % | 30 | 35 | 30 | — | 35 |
| | breakage and burrs | | | | | | |
| | Occurrence of | — | X | X | X | X | X |
| | breakage and burrs | | | | | | |

In Tables 1 and 2, PP represents polypropylene block copolymer and ABS represents an ABS resin. In Tables 1 and 2, numerical values (a1, a2, distance d between openings) were obtained by measurement at the cross section of the hollow-structure plate under a microscope. The bending radius R was measured at the edge of the opening of the convex portion.

Next, each of the hollow-structure plates was evaluated for “compressive strength”, “crushing processability”, “puncturing processability”, and “occurrence of breakage and burrs”.

### [Evaluation Method of Compressive Strength]

Each of the hollow-structure plates was cut into a size of 70×70 mm and was measured for a load at a yield point while being compressed at 5 mm/min. The obtained value was divided by the plane area to calculate the strength of the hollow-structure plate per cm². The measurement values in Tables 1 and 2 are averages obtained by N=5 measurement. The hollow-structure plate can be considered to be higher in compressive strength in the thickness direction as the measurement value is greater.

### [Evaluation Method of Crushing Processability]

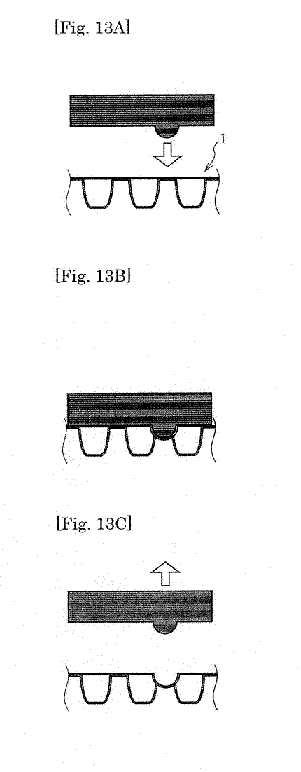

As illustrated in FIGS. 13A to 13C, each of the hollow-structure plates was pressed at an arbitrary temperature (50° C.) from the first surface material or second surface material side by a pressing machine in which a semi-cylindrical bar was placed such that an arbitrary R curve in the semi-cylinder (with a radius of 1 cm) contacts the hollow-structure plate. Each of the processed hollow-structure plates was subjected to pass/fail evaluation such that the hollow-structure plates having no error in thickness exceeding ±0.1 mm from an arbitrarily designed thickness and not being crushed at any portion other than the processed portion were marked with “∘”, and the hollow-structure plates with the foregoing problem were marked with “×”.

### [Evaluation Method of Puncturing Processability]

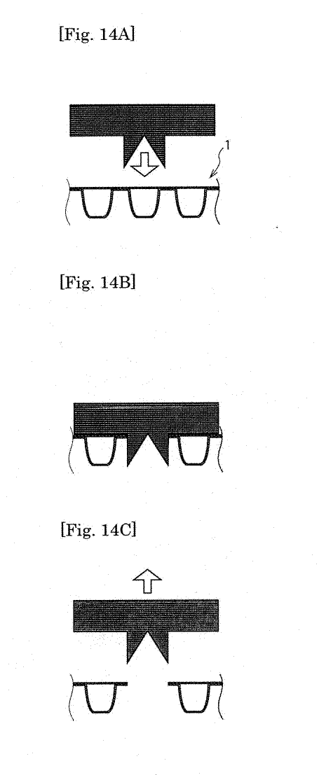

As illustrated in FIGS. 14A to 14C, each of the hollow-structure plates was pressed from the first surface material or the second surface material side at an arbitrary temperature (50° C.) by a publicly known method using a pressing machine with a Thomson blade (NEW CUTTER with a thickness of 1 mm manufactured by Nakayama Co., Ltd.). Each of the hollow-structure plates was subjected to pass/fail evaluation such that the hollow-structure plates not being crushed at any portion other than the processed portion were marked with “∘”, and the hollow-structure plates with the foregoing problem were marked with “×”.

### [Occurrence of Breakage and Burrs]

For this test item, each of the hollow-structure plates was evaluated for the occurrence of breakage and burrs (tears resulting from film processing) when the surface material side of the hollow-structure plate was laminated with a commercial PET film of 25 μm. The evaluation was made at N=20. Each of the processed hollow-structure plates was visually checked for the occurrence of breakage and burrs (the presence or absence of film tears) during the processing of the hollow-structure plate. The hollow-structure plates with breakage and burrs (the presence of film tears) were judged as failed and the occurrence rates of breakage and burrs (%) were calculated. The hollow-structure plates at occurrence rates of 10% or less were marked with “⊚”, and the hollow-structure plates at occurrence rates of more than 10 to 15% were marked with “∘”, and the hollow-structure plates at occurrence rates of more than 15% or incapable of evaluation were marked with “×”.

### 2. Considerations

The hollow-structure plates of examples 1 to 19 were easy to perform crushing process and puncturing process while retaining certain values or more of compressive strength (specifically, 0.80 or more). In addition, these plates had hardly breakage and burrs after the processing. Therefore, they were easy to process while retaining compressive strength. Meanwhile, the hollow-structure plates of comparative examples 1 to 6 were difficult to perform crushing process and puncturing process and had large quantities of breakage and burrs after the processing (the hollow-structure plate of comparative example 5 had a shaping failure and thus could not be evaluated for the foregoing items).

Therefore, the evaluation test results have revealed that setting the bending radius of at least part of the side wall of the convex portion to 0.75 to 20 mm would make it possible to obtain a hollow-structure plate that is easy to process while keeping compressive strength.

### INDUSTRIAL APPLICABILITY

According to the present invention, it is possible to obtain a hollow-structure plate that is easy to process while retaining compressive strength. Therefore, the hollow-structure plate according to the present invention can be favorably used in a wide range of areas, such as box materials and packing materials in physical distribution, walls and ceiling panel materials in buildings, and also automobile interior materials.

### REFERENCE SIGNS LIST

1: Hollow-structure plate
2: Hollow convex portion-formed sheet
21: Convex portion
211: Upper surface
212: Opening
3: Surface material
31: First surface material
32: Second surface material
4: Skin material
41: First skin material
42: Second skin material
101: T die
102: Extruder
103a, 103b: Decompression chamber
104a, 104b: Suction hole
R1: Roller with heating unit
R2: Shaping roller
R3: Flat roller
D1, D2: Molding die
P: Molten thermoplastic resin
θ1: Angle formed by line connecting centers of convex portions 21 in lateral direction and line connecting centers of convex portions 21 in oblique direction
h: Height of convex portion 21
d: Shortest distance between openings 212 of convex portions 21
F: Flow path
g: Arrow
k: Formation direction of flow path F
j: Flow direction of hollow-structure plate 1

1. A hollow-structure plate in which a surface material and/or a skin material are laminated to at least one surface of a hollow convex portion-formed sheet made from one or two thermoplastic resin sheets with a plurality of hollow convex portions on at least one surface, wherein at least part of a side wall of the convex portion has a bending radius R of 0.75 to 20 mm.

2. The hollow-structure plate according to claim 1, wherein the ratio (a1/a2) between a long diameter length a1 and a short diameter length a2 of an opening of the convex portion is 1.05≤a1/a2≤1.23.

3. The hollow-structure plate according to claim 1, wherein the ratio (a1/a2) between a long diameter length al and a short diameter length a2 of an opening of the convex portion is 1.08≤a1/a2≤1.21.

4. The hollow-structure plate according to claim 1, wherein the ratio (L/h) between total length L of a curve of the side wall of the convex portion with the bending radius R of 0.75 to 20 mm and height h of the convex portion is 0.05≤L/h≤0.3.

5. The hollow-structure plate according to claim 1, wherein the shortest distance between an openings of the convex portions is 0.5 to 5 mm.

6. The hollow-structure plate according to claim 1, wherein the shape of the convex portion is a truncated cone, an elliptical frustum, or a truncated polygonal pyramid.

7. The hollow-structure plate according to claim 1, wherein the shape of an opening of the convex portion is an ellipse.

8. The hollow-structure plate according to claim 1, wherein the hollow convex portion-formed sheet is made from one thermoplastic resin sheet with a plurality of frustum-shaped convex portions on one surface and is structured such that the surface material is laminated to an upper surfaces or openings or both of the convex portions.

9. The hollow gtructure plate according to claim 1, wherein the hollow convex portion-formed sheet is made from two thermoplastic resin sheets with a plurality of frustum-shaped convex portions on one each surface and is structured such that the two thermoplastic resin sheets are fused together with the convex portions 21 opposed to each other.
